(19) United States
(12) Patent Application Publication
(10) Pub. No.: US 2015/0059560 A1
(43) Pub. Date: Mar. 5, 2015

(54) Electric guitar having interchangeable electromagnetic Pickups

(71) Applicant: Raul Teodoro Perea Torres, Toledo (ES)

(72) Inventor: Raul Teodoro Perea Torres, Toledo (ES)

(21) Appl. No.: 14/391,709

(22) PCT Filed: Aug. 10, 2012
(86) PCT No.: PCT/ES2012/070605

§ 371 Date: Oct. 10, 2014

(30) Foreign Application Priority Data
Apr. 13, 2012 (ES) U201200352

(51) Int. Cl. G10H 3/18

(52) U.S. Cl. CPC G10H 3/18
USPC 84/726

(57) ABSTRACT

An electric guitar with interchangeable electromagnetic pickups characterised because the body of the guitar has a perforated cavity, not as a whole, from the height of the sixth string to the bottom of the instrument, including part of its edge, and from the height of the bridge to the beginning of the neck, intended by means of a downward-upward manual movement to house the cartridge where the pickups will be installed, in the same position under the strings as in other conventional guitars.

### OBJECT OF THE INVENTION

This invention refers, as indicated in the heading to these specifications, to a new model of electric guitar designed to obtain significant improvements and advantages over existing models.

This guitar model is designed to make it possible to use all registers, combinations and variations in the sound which can be obtained with the electromagnetic pickups currently on the market (simple, double, active, acoustic, etc.) without having to turn to another model of guitar which uses a combination different from ours.

### BACKGROUND OF THE INVENTION

Electric guitars use electromagnetic “pickups”, known by that name, to collect the vibration produced by the strings as they are plucked, and transform them into sound.

Over the years, the main guitar makers have stuck fundamentally to a given pickup type, each offering a characteristic and particular sound, so that each given type of guitar has its own sound, differentiating it from others.

The main drawback of this situation arises when attempting to emulate a given type of sound with a guitar which does not have the configuration appropriate for that and, to achieve the result desired, a musician has to use a different model guitar.

### DESCRIPTION OF THE INVENTION

The device consists of a wooden structure, called here a “cartridge” which contains the pickups, the volume and tone potentiometers and a jack type output for connection to the amplifier.

The lower part of the guitar, from the bottom to the height of the sixth string, is divided into sections and emptied to enable the cartridge to be moved into its corresponding position directly under the strings.

This sectioned part has a wooden dowel on the upper side, to secure the cartridge to the guitar.

The cartridge also has a mooring device which attaches it to the guitar and prevents it from dropping.

To complement the description given below and to aid in a better understanding of the invention, these specifications are accompanied by a set of plans whose figures enable the innovations and advantages of the device which is the subject of the invention to be understood better.

### A BRIEF DESCRIPTION OF THE DRAWINGS

FIG. 1: shows a ground view of the guitar with the part divided into sections and emptied for the cartridge to be introduced.

FIG. 2: shows a perspective view of the sectioned section where the cartridge is attached.

FIG. 3: shows a ground view of the device where the pickups and the rest of the electronics will be housed, and its upper edge.

FIG. 4: shows a ground view of the rear of the device and its edge.

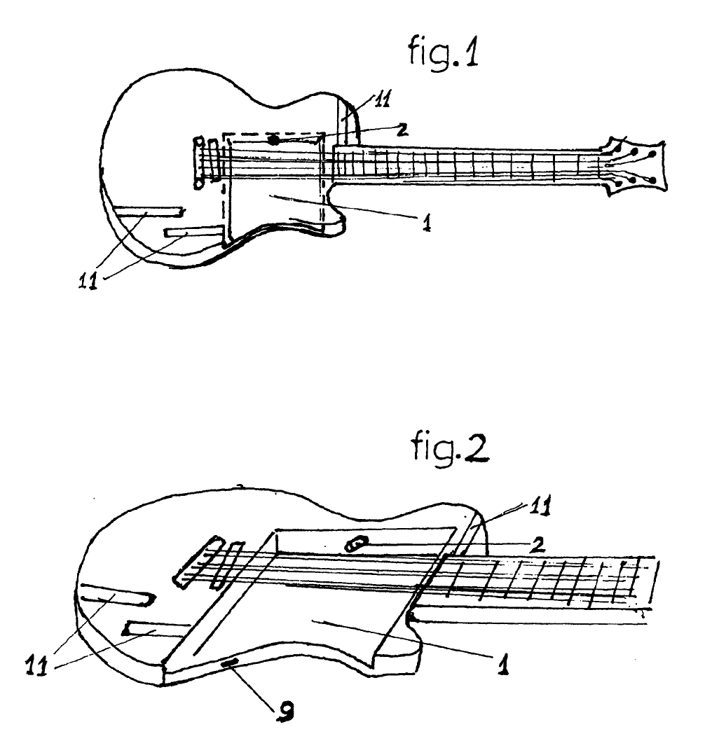

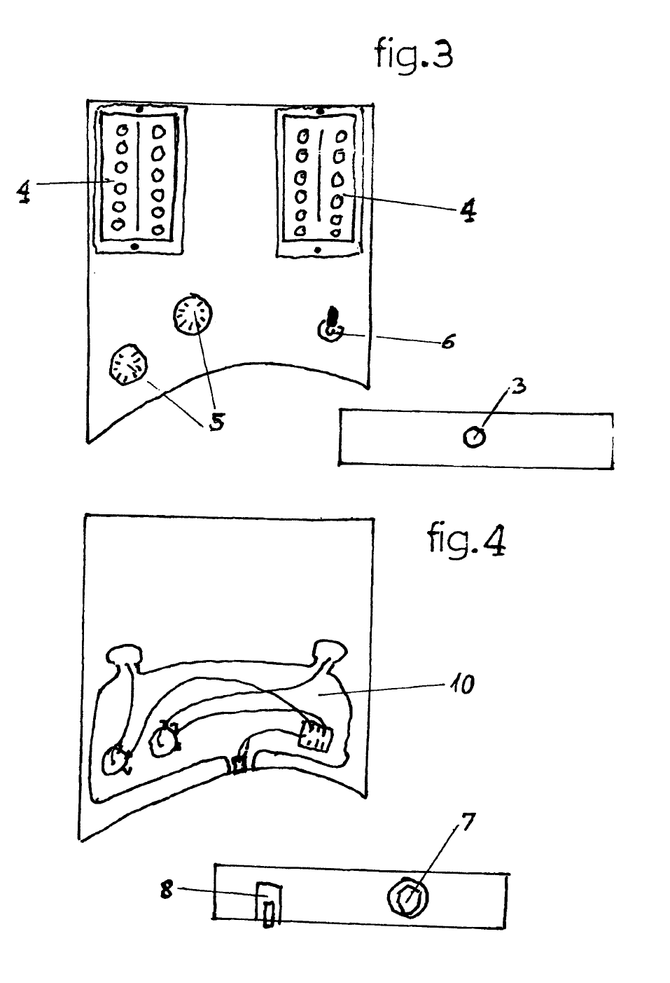

### DESCRIPTION OF A PREFERENTIAL EMBODIMENT

In the light of the description of the figures mentioned, it is seen that the model described consists of a guitar which has been sectioned and emptied (1), not as a whole, by the lower right-hand part from the height of the sixth string to the bottom of the guitar, including part of its edge. Within the perforated part, there is a wooden dowel (2) located in the upper part, which is connected to an opening (3) in the upper edge of the cartridge to secure the component and prevent it from moving.

The cartridge which, for aesthetic reasons, is of the same shape in its lower part as the sectioned part of the guitar, carries the electromagnetic pickups (4) on its front which, once attached to the guitar, are at the same height under the strings as on a conventional guitar. The volume and tone potentiometers (5) for the pickups are located in the lower part of the cartridge along with the 3 or 5 way switch (6) which makes the combinations among the pickups of each cartridge.

On the part of the edge is the jack type cable output (7) which is to carry the vibrations received from the pickups to the associated signal amplifier. There is also a mooring device (8) which, together with an element installed in the part of the edge of the guitar which has not been perforated (9), makes it possible to stabilise the cartridge inside the guitar so that it cannot fall or move.

There is a perforation (10) in the back of the cartridge for the installation of all the guitar hardware, cables, potentiometers, switches and the jack input, also protected by a cover in the same way as in traditional electric guitars.

Finally, the model has three aluminium components (11) embedded in three cuts distributed on the guitar's body, as decoration and differentiating element.

1. An electric guitar with interchangeable electromagnetic pickups, characterised because the body of the guitar has a perforated cavity, not as a whole, from the height of the sixth string to the bottom of the instrument, including part of its edge, and from the height of the bridge to the beginning of the neck, intended by means of a downward-upward manual movement to house the cartridge where the pickups will be installed, in the same position under the strings as in other conventional guitars.

2. An electric guitar with interchangeable electromagnetic pickups as set forth in claim 1, characterised because each cartridge inserted in the cavity in the guitar contains a specific electromagnetic pickup configuration and the rest of the electronics, differentiating it from other cartridges.

3. An electric guitar with interchangeable electromagnetic pickups as set forth in claims 1 and 2, characterised because a wooden dowel is located in the upper part of the cavity in the body, as stabiliser for the cartridge. Likewise, the part of the lower edge which has not been sectioned has a mooring device attaching the cartridge to the body so that it cannot fall off.
